(19) United States
(12) Patent Application Publication
(10) Pub. No.: US 2026/0109169 A1
(43) Pub. Date: Apr. 23, 2026

(54) HOLOGRAM DEVICE FOR NOVELTY ITEMS

(71) Applicant: HOLOPOP LLC, Virginia Beach, VA (US)

(72) Inventor: Ash Gilpin, Virginia Beach, VA (US)

(21) Appl. No.: 19/388,627

(22) Filed: Nov. 13, 2025

Related U.S. Application Data
(63) Continuation-in-part of application No. 19/081,994, filed on Mar. 17, 2025.
Application No. 19/081,994 is a continuation of application No. 18/821,505, filed on Aug. 30, 2024, now Pat. No. 12,251,954.
(60) Provisional application No. 63/536,204, filed on Sep. 1, 2023.

(51) Int. Cl. B42D 15/04

(52) U.S. Cl. CPC B42D 15/042

(57) ABSTRACT

A hologram display device configured for integration into novelty items such as plush toys, ornaments, calendars, or decorative products. The device includes a transparent or translucent housing enclosing a downward-facing display screen and an angled optical film. Visual content emitted from the display screen is reflected by the optical film to create a floating image visible through the housing. A controller renders animated or static content received wirelessly from a mobile device via a communication module. The system may include a speaker for synchronized audio playback and a user input for activation or pairing. The hologram display device is compact, self-contained, and suitable for embedding in soft or rigid novelty items, enabling personalized, animated, and seasonally themed visual effects. The system supports wireless content updates, allowing users to control and customize the displayed image through a companion application.

### CROSS-REFERENCE TO RELATED APPLICATIONS

This is a continuation-in-part application which is based upon U.S. application Ser. No. 19/081,994 filed Mar. 17, 2025, which is a continuation application of U.S. application Ser. No. 18/821,505 filed Aug. 30, 2024, which is based upon U.S. provisional Application No. 63/536,204 filed Sep. 1, 2023, the disclosures which are hereby incorporated by reference in their entirety.

### FIELD

The present invention relates generally to interactive toys and communication devices, and more particularly to a hologram device for novelty items.

### BACKGROUND

Stuffed animals and plush toys have long been popular as comfort items, gifts, and companions for children and adults alike. Traditional plush toys are often passive in function, serving primarily as soft, tactile objects without interactivity. Over time, manufacturers have introduced novelty features such as sound modules that play prerecorded phrases or melodies when a button is pressed, or embedded lights that flash in response to motion or touch. While these enhancements add some degree of interaction, they typically operate based on preprogrammed, non-customizable content and lack meaningful connectivity or user personalization.

Recent advancements in electronics and wireless communication have led to the development of “smart toys,” which may include Bluetooth connectivity, touch-sensitive surfaces, or integration with mobile applications. However, such toys often emphasize robotics or voice-based interactions, and are typically housed in hard plastic shells or mechanical forms rather than soft plush constructions. This limits their appeal in settings where emotional connection and tactile comfort are key attributes, such as in bedtime use or as personalized gifts.

Moreover, while some toys incorporate small LCD or LED displays, these are usually externally visible on rigid surfaces and do not attempt to integrate visually immersive or dynamic effects within the soft body of a stuffed toy. There remains a need for a soft plush toy that can display animated visual effects and personalized messages in a novel, engaging, and user controllable manner to bridge the gap between traditional plush toys and modern digital interactivity.

### SUMMARY

A hologram device for novelty items is disclosed. The hologram display device configured for integration into novelty items such as plush toys, figurines, wearable accessories, and decorative products. The device includes a compact display module housed within a transparent or translucent enclosure, which creates a floating or holographic visual effect. The module incorporates an internal screen, optical elements, control electronics, and a wireless communication interface that enables content to be transmitted from an external device, such as a smartphone or tablet.

The display screen projects animations or messages onto an angled optical film positioned inside the enclosure. This film reflects the image back toward the viewer, producing the illusion of a three-dimensional, suspended animation within the housing. The device may also include an audio component to play recorded voice messages or sound effects.

The hologram device is activated and controlled through user input or a companion mobile application. Once paired via Bluetooth or other wireless protocols, the user can select animations, text messages, or audio clips from a content gallery or upload personalized content. The selected media is wirelessly transmitted to the device for playback.

This invention enables a new form of expressive and personalized novelty item by combining traditional physical products with dynamic, programmable holographic display technology. It provides a compelling platform for gift-giving, emotional communication, decorative enhancement, and brand engagement through immersive visual effects. Other aspects, advantages, and features of the present disclosure will become apparent after review of the entire application, including the following sections: Brief Description of the Drawings, Detailed Description, and the Claims.

### BRIEF DESCRIPTION OF THE DRAWINGS

The aspects and the attendant advantages of the embodiments described herein will become more readily apparent by reference to the following detailed description when taken in conjunction with the accompanying drawings wherein:

FIG. 1 is a perspective view of an example novelty item in the form of a Christmas ornament globe;

FIG. 2 is a front view of the ornament globe in use, illustrating the holographic visual effect created by projection of display content onto the angled optical film, as seen through the transparent housing;

FIG. 3 is a front perspective view of a stuffed animal novelty item with the hologram display device embedded in the torso region;

FIG. 4 is a front view of an advent calendar display, showing the hologram display device positioned in a central window or compartment;

FIG. 5 is a schematic diagram illustrating the electrical and functional components of the hologram display device; and

FIG. 6 is a flow diagram illustrating a method of displaying a holographic visual effect.

### DETAILED DESCRIPTION

1 The present invention will now be described more fully hereinafter with reference to the accompanying drawings, in which preferred embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

Referring now to FIG. 1, a novelty item in the form of a Christmas ornament 104 is shown incorporating a compact hologram display system designed to generate a floating visual effect within a sealed spherical enclosure. The ornament includes a spherical outer housing 106 formed from a transparent or translucent optical-grade material such as polycarbonate or acrylic. Housing 106 permits unobstructed external viewing of visual content projected within the internal display cavity.

Mounted within the upper interior portion of housing 106 is a horizontally oriented electronics assembly 118, which includes all functional electrical components of the system. Electronics assembly 118 is supported by a rigid internal structure, such as a molded tray or mounting plate, affixed to the inner surface of housing 106. This horizontal mounting configuration provides a stable support base and ensures alignment of the display axis and optical reflector while preserving the visual and geometric symmetry of the ornament 104.

A display screen 110 is mounted below electronics assembly 118 and oriented to face downward toward the central volume of housing 106. Display screen 110 may comprise a thin-film transistor liquid crystal display, an OLED panel, or other suitable emissive or transmissive panel capable of rendering static or animated content. The screen emits light downward along a vertical optical axis aligned with the central longitudinal axis of the ornament 104.

Suspended below display screen 110 is an angled optical film 108 configured to reflect the emitted light from screen 110 outward toward a frontal viewing region of housing 106. Optical film 108 is supported at a fixed oblique angle relative to the horizontal plane of electronics assembly 118. Film 108 may be formed from a metallized or dielectric-coated PET sheet, partially reflective and partially transmissive, optimized for controlled angular reflection of projected image content. The physical position and angular orientation of optical film 108 are selected to produce a reflected image that appears to float within the center of housing 106, visible to a viewer looking through the front of ornament 104.

Electronics assembly 118 includes a controller 112 operatively connected to display screen 110. Controller 112 includes a microprocessor, memory, and input-output interfaces configured to manage visual content rendering, power delivery, and communication functions. A wireless communication module 114 is integrated into the same circuit platform as controller 112 or electrically connected thereto. Communication module 114 may comprise a Bluetooth Low Energy transceiver or similar short-range wireless interface configured to pair with an external mobile device and receive image, animation, or message data for playback on display screen 110.

Power is supplied by a battery 116 mounted on or adjacent to electronics assembly 118. Battery 116 may be a rechargeable lithium-polymer cell or other compact power source sufficient to operate the display system for several hours per charge. In some embodiments, the electronics assembly includes a charging interface 115, enabling connection to a USB cable or wireless charging pad. Power management circuitry 117 is included within controller 112 or a dedicated subcircuit to regulate charge and discharge cycles and to shut down the system after periods of inactivity.

The spatial arrangement of display screen 110 and optical film 108 within housing 106 creates a distinct visual projection pathway. Light emitted from screen 110 is projected downward and strikes the inclined surface of optical film 108. The film reflects this light outward through the transparent wall of housing 106, generating a virtual image that appears to float in mid-air within the body of ornament 104. Because optical film 108 is partially transmissive, it also allows ambient light to pass through, enhancing the depth and realism of the floating image without requiring a background or backlight.

Electronics assembly 118 is physically isolated from the optical volume below to avoid introducing visual obstructions or clutter into the display region. The compact, top-mounted structure of the internal system ensures that ornament 104 retains a clean appearance, balanced center of gravity, and stable optical alignment. The arrangement of horizontally stacked components also facilitates modular assembly, with electronics assembly 118 being insertable into housing 106 as a pre-assembled subunit.

This configuration provides multiple non-obvious benefits. First, the horizontal layout of display screen 110 combined with the downward projection path and angled reflection by optical film 108 creates a hologram-like illusion that does not require direct view of a physical screen. Second, the use of partial reflection allows dynamic image content to be displayed without obstructing ambient visibility or requiring complex mechanical optics. Third, by localizing all electronics in the upper portion of housing 106, the system maintains visual integrity of the central cavity while also protecting components from vibration or user handling. Finally, the system supports wireless programming of image content through communication module 114, enabling seasonal, customized, or user-generated visual experiences without physical modification of ornament 104.

In operation, controller 112 receives wireless content data via communication module 114 and drives display screen 110 to emit visual content downward. This content is reflected by optical film 108 to create a visible floating image 121 within the transparent sphere of housing 106. Ornament 104 thus functions as an interactive, customizable holographic novelty item that combines passive optical design with active wireless control and compact embedded electronics.

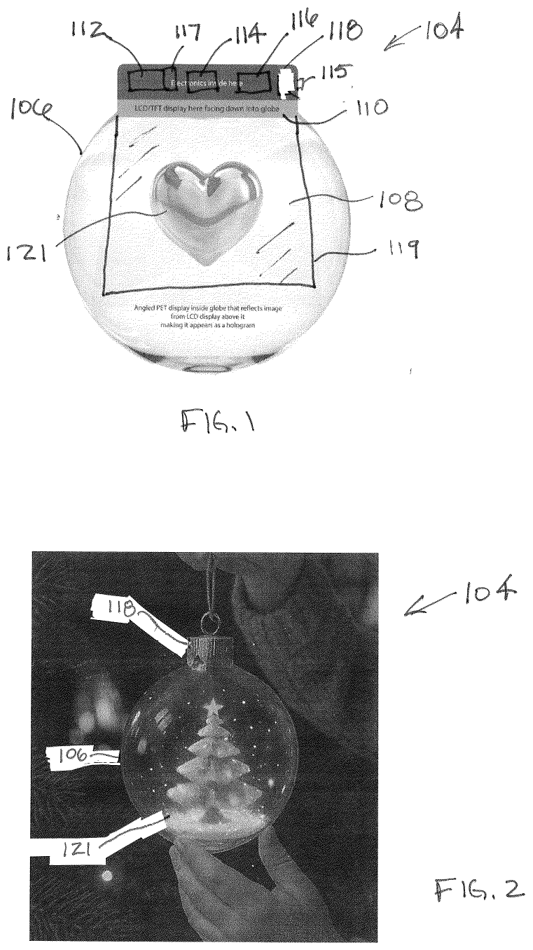

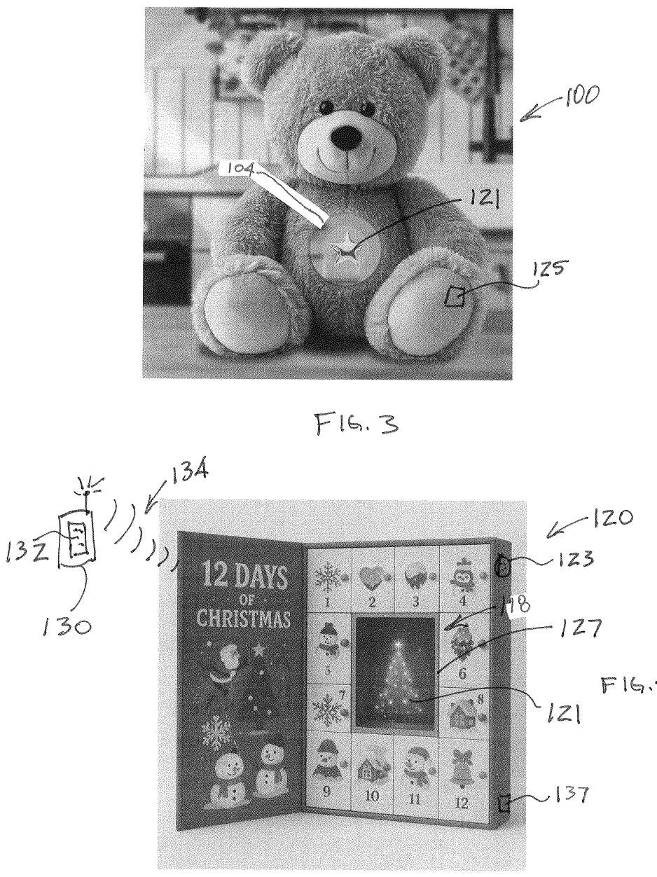

Turning to FIG. 2, the ornament 104 is shown in front view during active operation of the hologram display system. The spherical housing 106, formed of transparent material, allows visual observation of the projected holographic image 121 within the interior cavity. Mounted near the upper interior region of the housing is the display screen 110, which is oriented horizontally and faces downward into the optical cavity.

The display screen 110 emits digital visual content, such as animated images, symbols, or messages, which is projected downward along a vertical axis. Disposed below the screen is an optical film 108, which is suspended at an oblique angle between the screen and the viewer-facing portion of the housing. The optical film 108 is configured as a thin, partially reflective surface, such as a metallized PET sheet or coated polymer film, that reflects the downward-projected light outward through the front of the ornament toward the observer.

The interaction between the downward-facing display screen 110 and the angled optical film 108 creates a floating image 121 within the central volume of the housing 106. The viewer perceives a virtual image 121 that appears to hover in mid-air, occupying a depth zone between the optical film 108 and the front surface of the housing 106. Because the image 121 is reflected rather than directly emitted toward the viewer, there is no physical substrate or background supporting the image, which enhances the illusion of suspension.

The apparent position and stability of the image 121 are functions of both the film angle and the relative height of the display screen 110 above the film. The system geometry is configured so that the reflected image 121 appears centered when viewed from a typical frontal angle. The use of a semi-transparent optical film 108 enables ambient background light to pass through, enhancing the illusion of spatial depth and enabling subtle parallax effects as the position of the viewer changes.

In addition, the system supports dynamic content display. The controller 112, mounted on the same horizontal platform as the display screen 110, receives content data from a paired mobile device via the wireless communication module 114. The controller 112 decodes and renders visual data frame by frame, enabling the display of animations, transitions, or timed sequences. The resulting output is emitted by the display screen 110 and reflected by the optical film 108 in real time, allowing for rich, customizable content delivery.

The use of the optical film 108 rather than a full mirror surface avoids unwanted glare and over-reflection. The partial reflectivity of the film ensures that only the desired image is strongly reflected, while minimizing secondary reflections from other components or external light sources. The selected film material and coating are optimized for reflectivity and transparency balance, which improves contrast, reduces visual clutter, and maintains the purity of the projected content.

The spherical shape of housing 106 further enhances the viewing experience by enclosing the reflected image in a continuous, distortion-minimized shell. The geometry of the globe creates a subtle magnification and framing effect, helping to concentrate the viewer's attention on the central floating image. Because there are no visible wires, connectors, or structural supports in the image zone, the projection appears clean and visually self-contained.

In some embodiments, the ornament 104 may include additional visual enhancements such as background lighting or translucent diffusers above or below the optical film 108 to simulate glow or halo effects. However, the core floating image effect is achieved solely through the alignment and cooperation of the display screen 110 and the angled optical film 108 within the transparent housing 106.

This configuration achieves a non-obvious combination of display geometry, projection optics, and spatial packaging. The horizontally oriented display screen 110, in conjunction with the suspended angled optical film 108, allows for compact internal structure while generating an immersive, suspended image effect visible through housing 106. The design is robust, modular, and easily integrated into novelty items such as ornaments, offering a scalable platform for consumer-facing animated visual experiences.

Referring now to FIG. 3, a novelty item in the form of a plush toy 100 is shown incorporating the hologram display system described in FIGS. 1 and 2. Plush toy 100 may be configured in the shape of an animal, character, or other soft-bodied form commonly used for comfort, gifting, or decorative purposes. The exterior of plush toy 100 is formed from a soft fabric shell, such as polyester fleece or cotton blend, and is filled with padding or stuffing material to create a compressible and tactile body.

Embedded within the torso region of plush toy 100 is a hologram display assembly substantially similar to the assembly shown in ornament 104 of FIG. 1. The display assembly is housed within a transparent or translucent enclosure 106 that may be spherical, dome-shaped, or rounded to allow multidirectional visibility of the projected image 121. In the plush embodiment, enclosure 106 is partially recessed or supported within the body cavity of plush toy 100 and may be surrounded by a foam frame or stitched reinforcement layer to stabilize the housing while maintaining the softness and flexibility of the surrounding material.

As in the previous embodiments, the display assembly includes a display screen 110 mounted in a horizontal orientation near the upper portion of enclosure 106. Display screen 110 is directed downward toward an optical film 108 suspended at an oblique angle within the enclosure. The screen projects visual content downward, which is reflected outward by optical film 108, creating a floating image 121 visible through the transparent face of enclosure 106. The projection geometry remains consistent with the optical pathway described in FIG. 2, but the plush toy embodiment introduces additional constraints relating to alignment, depth, and body contouring.

The display screen 110 is operatively connected to the controller 112, which may be mounted directly above or behind the screen and embedded within the electronics compartment of the torso. Controller 112 manages content rendering, power delivery, and communication functions. A wireless communication module 114, such as a Bluetooth transceiver, enables controller 112 to pair with a mobile device and receive animation or message content wirelessly. The system may be preloaded with default animations and can be updated remotely by a user through a companion application.

A power source 116 is also embedded within the body cavity, preferably in a location above or beside enclosure 106. Power source 116 may comprise a rechargeable battery pack protected by a soft housing, and may be accessible via a hidden zipper or Velcro opening on the back of plush toy 100. The power system may be coupled with a power management circuit to provide charging protection, low-voltage cutoff, and energy-efficient sleep mode functionality.

User input may be provided via a capacitive or mechanical input switch embedded in a limb or surface of plush toy 100. In one embodiment, a capacitive sensor pad 125 is located in one of the paws and is connected to the controller 112. A short press on the paw activates the display, while a long press initiates pairing mode with an external mobile device. This arrangement allows interaction without exposing physical buttons, thereby maintaining the soft aesthetic and tactile comfort of the toy.

The integration of the hologram display within plush toy 100 presents several non-obvious advantages. First, the optical display system is fully contained within a clear enclosure 106, allowing it to be securely embedded in a soft body without risk of damage or misalignment from compression. Second, the centralized torso placement ensures that the floating image remains visible even when the toy is handled, hugged, or positioned on a shelf or bed. Third, the use of a downward-facing display screen 110 and an angled optical film 108 enables full projection within a limited depth cavity, reducing the thickness of the module required and preserving the overall softness of the toy.

In addition, the plush embodiment provides enhanced emotional and expressive value. Floating images 121 such as pulsing hearts, rotating stars, animated characters, or custom text messages can be displayed in the torso of plush toy 100 to simulate emotion or send personalized greetings. These images may be static or animated and can include synchronized audio playback via an optional speaker connected to controller 112. In use, a child or recipient can activate the toy and receive a floating image 121 accompanied by a voice message, seasonal greeting, or visual effect, enhancing the emotional impact of the toy.

The hologram display module is designed for durability and safety, using impact-resistant materials and concealed edges to prevent injury or damage during normal use. The clear housing 106 is shatter-resistant and may be covered with a soft mesh layer or protective film to meet child-safety standards. The electronic components are enclosed in insulating compartments, and the system may include over-temperature and short-circuit protection features.

Overall, FIG. 3 illustrates how the hologram display system can be seamlessly integrated into a soft-bodied novelty item such as plush toy 100, enabling personalized, animated, and immersive visual experiences without compromising the tactile, comforting properties traditionally associated with stuffed toys.

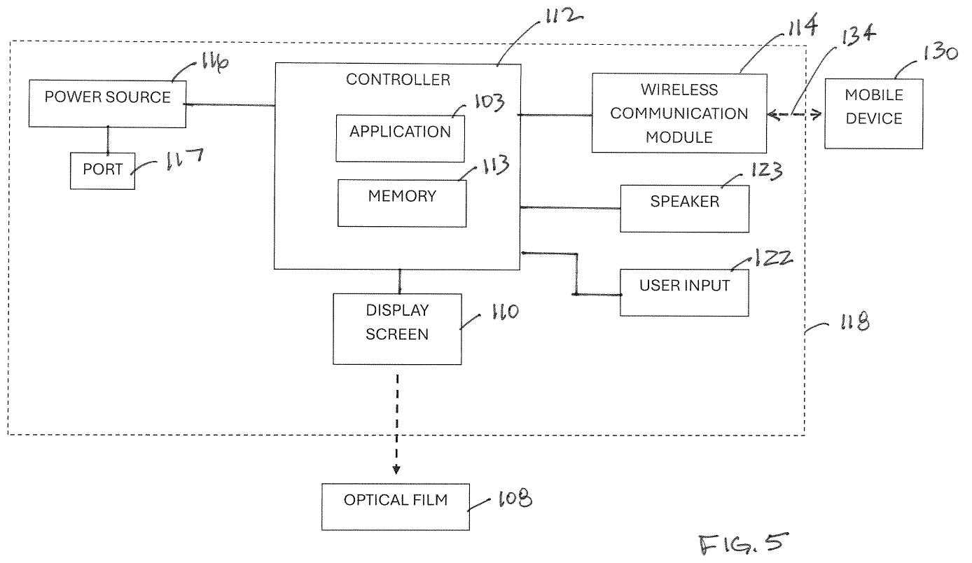

Referring now to FIG. 4, an advent calendar 120 is illustrated incorporating the hologram display system as a central visual and interactive element. Advent calendar 120 includes a front panel divided into a plurality of compartments or windows, each corresponding to a calendar day in the advent period. The layout may follow a standard grid format with twenty-four or twenty-five compartments, each intended to be opened on its corresponding day to reveal a treat, token, or message.

Centrally positioned within the body of advent calendar 120 is a hologram display module that includes a transparent or translucent housing 127 similar to that described in FIGS. 1 through 3. The housing 127 may be rectangular shaped depending on the overall design aesthetic of the calendar. The housing 127 is embedded in a reinforced section of the calendar backing or facade, and is positioned to be visible throughout the entire advent period, serving as a persistent focal point.

Mounted within housing 127 is a horizontally oriented electronics assembly 118 that supports a display screen 110, an optical film 108, and all required electronics to produce a floating visual effect. The display screen 110 is mounted near the top of the interior volume and faces downward. Optical film 108 is suspended at an oblique angle below the screen and functions as a semi-reflective surface to redirect projected visual content outward through the front of housing 127.

The controller 112 is mounted on the electronics assembly 118 and is connected to the display screen 110. The controller 112 is configured to process content and render visual animations or images 121. The wireless communication module 114 is integrated into or connected to the controller 112 and enables the system to pair with a mobile device 130 via wireless link 134. Content is transmitted from mobile device 130 through user interface 132, which may include an app for selecting animations, messages, countdown graphics, or themed effects. A power source 116 supplies energy to the system and may be rechargeable or replaceable. In some embodiments, the calendar may also include a discreetly located charging interface 137.

In operation, the hologram display module embedded in the advent calendar 120 serves multiple dynamic functions. On each day of the advent period, a user may interact with the calendar by opening one of the compartments and optionally scanning a code, pressing a button, or triggering a sensor linked to the user input 122. This input may prompt controller 112 to display a specific animation or message associated with that day. For example, on December 1, display screen 110 may show a floating number “1” with a festive visual effect, followed by a themed animation such as falling snow or a twinkling star. On subsequent days, different effects or custom messages may be shown.

Unlike traditional advent calendars which are limited to static, preprinted content or consumable goods, the present system allows dynamic, programmable visual content to be displayed and updated in real time. The floating image, produced by the interaction between display screen 110 and optical film 108, creates a holographic image 121 that appears to hover within the central region of advent calendar 120, viewable through housing 127. The viewer perceives the image as being suspended in mid-air, creating an engaging and magical visual experience, particularly well-suited to seasonal and holiday themes.

This arrangement offers several non-obvious advantages. First, it allows the calendar to be reused annually, with content updated via wireless transmission from a companion app. Second, it enables real-time personalization, such as allowing a parent to record a custom message or animation for each day of the advent period. Third, by using a single centrally positioned display module, the system eliminates the need to embed electronics in each daily compartment, simplifying manufacturing and reducing power requirements.

In some embodiments, advent calendar 120 may include synchronization features, such that content displayed on screen 110 corresponds precisely to the compartment opened on a given day, either by physical sensing (e.g., contact switches behind doors) or manual selection through mobile device 130. Additional accessories such as speaker 123 may be embedded to provide synchronized audio playback, enhancing the emotional and experiential value of the visual presentation.

FIG. 4 therefore illustrates a novel application of the hologram display system within a seasonal novelty item, where the central floating display serves as an interactive countdown or storytelling feature that can be updated, customized, and reused year after year, while delivering a visually compelling and emotionally rich holiday experience.

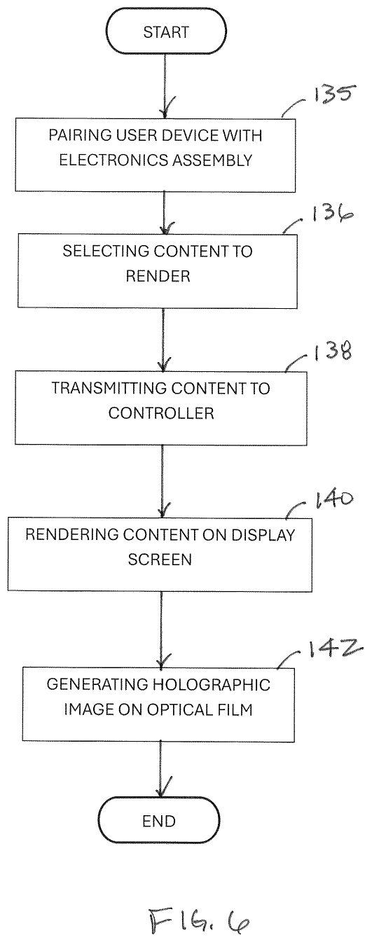

Referring now to FIG. 5, a schematic block diagram is shown illustrating the principal electrical and functional components of the hologram display system used in each of the novelty item embodiments described in FIGS. 1 through 4. This configuration may be implemented within ornament 104, plush toy 100, advent calendar 120, or other novelty items into which the system may be integrated.

At the center of the schematic is a controller 112, which may be a microcontroller unit, system-on-chip (SoC), or other programmable logic device. Controller 112 is responsible for managing power distribution, communication functions, and rendering of visual content. It includes an application 103 internal or external memory 113 for storing image data, animations, or configuration settings. Controller 112 is operatively connected to a display screen 110, which may be a thin-film transistor (TFT) display, OLED panel, or LCD capable of emitting full-color or grayscale visual content. Display screen 110 is oriented to project content downward in physical embodiments, and is controlled via digital signals from controller 112.

An optical film 108 is not an electrical component, but is shown in FIG. 5 for functional clarity, representing its optical interaction with display screen 110. Optical film 108 is angled within the device housing to receive the downward light output from screen 110 and reflect it outward to the viewer to create a floating image. The reflection path from screen 110 through optical film 108 is indicated as a directional arrow in the figure to denote the image projection flow.

Controller 112 is connected to a wireless communication module 114. This module may be implemented on a shared PCB or as a discrete chip or daughterboard, and is configured to support Bluetooth, Bluetooth Low Energy (BLE), Wi-Fi, or other wireless protocols. Wireless module 114 enables pairing with a mobile device 130 over a wireless link 134, allowing user-selected content to be transmitted to the display system. A graphical user interface 132 executed on mobile device 130 facilitates selection of animations, message text, or image files by the user. These are packaged and transmitted over wireless link 134 to wireless module 114, which relays the data to controller 112 for processing and rendering.

A power source 116 supplies electrical power to controller 112, display screen 110, and wireless module 114.

Power source 116 may be a rechargeable lithium-ion or lithium-polymer battery in portable embodiments such as plush toys and ornaments, or may be a removable coin-cell battery in simpler implementations. Controller 112 optionally includes integrated power management circuitry to control charge, regulate voltage, and initiate sleep mode during periods of inactivity to conserve energy.

Optional components include a user input 122 and a speaker 123. User input 122 may be a mechanical push button, capacitive touch pad, motion sensor, or any tactile interface embedded in the novelty item. Input 122 is connected to controller 112 and may be configured to initiate system power-on, trigger pairing, or cycle through stored content. Speaker 123 is connected to an audio output pin or driver circuit on controller 112 and is used to play back synchronized audio, such as a user-recorded voice message, a holiday tune, or a sound effect paired with the holographic display.

Charging interface 117 may also be included in embodiments using rechargeable power source 116. Charging interface 117 may be implemented as a USB-C or micro-USB port, a magnetic connector, or an inductive charging coil. In configurations where physical access is limited (such as sealed ornaments), charging interface 117 may be fully internal and accessible only through specialized cradles or pads.

The structure illustrated in FIG. 5 highlights several non-obvious advantages. First, the use of a dedicated controller 112 that communicates bidirectionally with wireless module 114 allows for dynamic content updates and reconfiguration without any mechanical user interface. Second, the pairing of downward-facing display screen 110 with fixed-angle optical film 108 enables generation of the floating image effect without the need for moving mirrors, lenses, or volumetric projection hardware.

Third, the modular design shown in the schematic allows this system to be embedded into a variety of form factors and novelty items with minimal changes to the core electronics.

Thus, FIG. 5 illustrates the core control and communication architecture of the hologram display system, which provides the functionality necessary to render and display custom visual content within a novelty item using a simple, compact, and wirelessly programmable platform.

Referring now to FIG. 6, a flow diagram is shown illustrating a method for displaying a holographic visual effect using the hologram display device integrated into a novelty item such as plush toy 100, ornament 104, or advent calendar 120. The method begins when a user interacts with a mobile device 130 configured to execute a graphical user interface 132 for controlling the hologram device.

The first step in the method is pairing the mobile device 130 with the novelty item, shown as step 135. In some embodiments, pairing is initiated automatically when the novelty item is powered on or is triggered manually via a user input 122 embedded in the novelty item. Input 122 may be a physical button, capacitive sensor, or motion-activated switch. When activated, controller 112 signals wireless communication module 114 to begin advertising for a Bluetooth or similar short-range connection.

Once pairing is established via wireless link 134, the user is presented with the graphical user interface 132 on mobile device 130. This interface enables the user to browse, select, or customize content. At step 136, the user selects content from a gallery or uploads personalized media, such as an animated heart, spinning star, scrolling text, or a custom holiday message. This content is transmitted over wireless link 134 from mobile device 130 to wireless module 114, at step 138, and then passed to controller 112 for processing.

At step 140, controller 112 renders the received content onto display screen 110. The content may be static, animated, or interactive, and is rendered in a format suitable for downward projection onto the optical film 108. The controller may apply transformations to account for optical distortion, brightness calibration, or timing synchronization if the visual is paired with audio from speaker 123.

At step 142, the holographic image is generated by the physical interaction between the downward-facing display screen 110 and the angled optical film 108. As the rendered image is emitted from screen 110, it is reflected outward through optical film 108 toward the transparent front of housing 106, creating the appearance of a floating or suspended image within the novelty item. The user perceives the image as hovering in mid-air due to the specific orientation and reflectivity of the optical film 108 and the optical geometry of the housing 106.

The system may remain active for a predetermined duration or until a timeout occurs. Power source 116 supplies energy throughout the process, and controller 112 may enter a sleep state after the display cycle ends. In some embodiments, the user may send follow-up commands from mobile device 130 to adjust brightness, cycle between stored messages, or schedule recurring displays.

This method, as shown in FIG. 6, highlights multiple non-obvious interactions. First, it allows fully wireless programming of visual content without the need for physical media, ports, or buttons. Second, it leverages digital rendering and optical reflection to create a holographic effect using fixed components, without mechanical optics or projection mapping. Third, it enables highly personalized visual experiences that can be synchronized with seasons, events, messages, or emotional gestures—all initiated by a simple mobile app interface and projected into a visually striking novelty item.

FIG. 6 therefore illustrates an efficient and scalable method for creating, controlling, and displaying personalized holographic effects in a wide variety of consumer products using compact hardware and user-friendly software.

The previous description of the disclosed embodiments is provided to enable any person skilled in the art to make or use the disclosed embodiments. Various modifications to these embodiments will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope possible consistent with the principles and novel features as defined herein.

1. A hologram display device for integration into a novelty item, the device comprising:
a housing formed from a transparent or translucent material;
a display screen positioned within the housing and configured to emit visual content;
an optical film disposed within the housing and angled relative to the display screen, the optical film being configured to reflect the visual content to create a floating image effect viewable from outside the housing;
a controller operatively coupled to the display screen;
a wireless communication module configured to receive content data from an external device; and
a power source configured to supply power to the display screen and the controller;
wherein the controller is configured to render the received content data as one or more visual effects on the display screen.

2. The device of claim 1, wherein the display screen comprises an LCD, OLED, or TFT panel.

3. The device of claim 1, wherein the optical film comprises a partially reflective PET sheet.

4. The device of claim 1, wherein the housing is generally spherical or dome-shaped.

5. The device of claim 1, further comprising a speaker configured to play an audio message associated with the received content data.

6. The device of claim 1, wherein the novelty item is a plush toy, and the housing is embedded in a torso region of the toy.

7. The device of claim 1, further comprising a user input sensor disposed in the novelty item and configured to activate the device or initiate pairing.

8. The device of claim 1, wherein the wireless communication module comprises a Bluetooth interface.

9. The device of claim 1, wherein the controller is configured to store a plurality of content files in memory and selectively render content based on user input.

10. The device of claim 1, wherein the content data comprises an animation, a message, or a combination thereof.

11. A method for displaying a floating image in a novelty item, the method comprising:
receiving content data wirelessly from an external mobile device;
storing the content data in a memory associated with a controller;
rendering, by the controller, a visual representation of the content data on a display screen disposed within a transparent or translucent housing; and
reflecting the visual representation toward an exterior of the housing using an angled optical film to produce a floating image effect visible from outside the housing.

12. The method of claim 11, further comprising receiving a user input from a sensor embedded in the novelty item to initiate the wireless connection.

13. The method of claim 11, further comprising playing an audio message in coordination with the visual representation.

14. The method of claim 11, wherein the content data comprises an animated image or text-based message.

15. The method of claim 11, further comprising entering a low-power or sleep mode after a predetermined period of inactivity.

16. The method of claim 11, further comprising transmitting the content data from a mobile application with a user interface that enables selection or customization of visual content.

17. A system for providing holographic display functionality in a novelty item, the system comprising:
a novelty item including a hologram display device, the device comprising
a housing formed from a transparent or translucent material,
a display screen disposed within the housing,
an optical film angled relative to the display screen and configured to reflect the visual content outward,
a controller operatively connected to the display screen,
a wireless communication module, and
a power source;
a mobile device including a graphical user interface and a wireless communication module;
wherein the mobile device is configured to transmit content data to the novelty item, and
wherein the controller renders the content data as a visual effect that appears as a floating image when reflected by the optical film.

18. The system of claim 17, wherein the mobile device executes an application that allows a user to select, customize, and transmit animations or messages.

19. The system of claim 17, wherein the novelty item further includes a speaker to play an audio message in synchronization with the visual effect.

20. The system of claim 17, wherein the novelty item comprises a plush toy, a decorative figurine, or a wearable item, and the hologram display device is embedded within a visible region of the item.
